(19) United States
(12) Patent Application Publication
(10) Pub. No.: US 2013/0054131 A1
(43) Pub. Date: Feb. 28, 2013

(54) FAST PATH PLANNING NAVIGATION APPARATUS AND METHOD THEREOF

(71) Applicant: Hua-En ZHANG, Shanghai (CN)

(72) Inventor: Hua-En ZHANG, Shanghai (CN)

(21) Appl. No.: 13/243,269

(22) Filed: Sep. 23, 2011

(30) Foreign Application Priority Data
Aug. 29, 2011 (CN) 201110251278.2

(51) Int. Cl. G01C 21/34

(52) U.S. Cl. 701/410

(57) ABSTRACT

The present invention discloses a fast path planning navigation apparatus and a method thereof. The navigation apparatus comprises a map database, an input module, a positioning module and a processing module. The map database stores an expressway map and an urban road map. The input module inputs a destination. The positioning module calculates the current location of the navigation apparatus according to a global positioning system signal, the expressway map and the urban road map. The processing module calculates path information for a current location of the navigation apparatus to entrance ramp and exit ramp to the destination according to expressway information, the expressway map and the urban road map.

### CROSS-REFERENCE TO RELATED APPLICATION

This application claims the benefit of China Patent Application No. 201110251278.2, filed on Aug. 29, 2011, in the China Intellectual Property Office the disclosure of which is incorporated herein by reference.

### BACKGROUND OF THE INVENTION

1. Field of the Invention

The present invention relates to a fast path planning navigation apparatus and a method thereof, and more particularly to a navigation apparatus and a method for planning a path more quickly by calculating road information in advance.

2. Description of the Related Art

In general, a navigation apparatus calculates an appropriate path according to a current location and a destination given by a user while performing a path planning For planning a long-distance path, the navigation apparatus requires longer calculation time. However, most of the long-distance paths are on freeways, so that approximately half of the calculation time of the navigation apparatus is used for calculating path information on freeways.

Present navigation apparatuses are too slow for planning a long-distance path, and for example, it takes approximately 10˜20 seconds to plan a long-distance path from Beijing to Shanghai. In addition to the long calculation time, the navigation apparatus may also have the problems that the navigation apparatus tends to crash or the memory of the navigation apparatus tends to be insufficient due to a larger the computational load required by the planning of a long-distance path.

It is noteworthy to point out that regardless of the starting point or the destination of a planned long-distance path, the distance from an entrance ramp to an exit ramp of a freeway remains constant. However, the conventional navigation apparatus has to calculate all paths including urban roads and freeways at a time for each calculation for planning the long-distance path. Thus, as long as performing a long-distance path planning, the navigation apparatus has to spend much time to calculate existing freeway and expressway information once again for the planning of a long-distance path each time.

The conventional navigation apparatus not only causes tremendous inconvenience for users to operate and use the navigation apparatus, but also causes the problems that the navigation apparatus tends to crash of the navigation apparatus and the computational load is overloaded.

Obviously, it is a main subject for related designers and manufacturers to design and develop a fast path planning navigation apparatus and a method thereof to overcome the technical deficiencies and shortcomings of the prior art.

### SUMMARY OF THE INVENTION

In view of the aforementioned shortcomings of the prior art, it is a primary objective of the present invention to provide a fast path planning navigation apparatus and a method thereof in order to overcome the drawbacks of the prior art that takes too much calculation time for the planning of a long-distance path.

To achieve the foregoing objective, the present invention provides a navigation apparatus, comprising a map database, an input module, a positioning module and a processing module. The map database is provided for storing an expressway map and an urban road map; the input module is provided for inputting a destination; the positioning module is provided for calculating a current location of the navigation apparatus according to a global positioning system signal, the expressway map and the urban road map; and the processing module is provided for calculating path information from the current location of the navigation apparatus to the entrance ramp and from the exit ramp to the destination according to the expressway information, the expressway map and the urban road map.

Wherein, the navigation apparatus further comprises an external computer for calculating expressway information from an entrance ramp to an exit ramp according to the expressway map.

Wherein, the map database is provided for storing the expressway information from the entrance ramp to the exit ramp.

Wherein, the navigation apparatus further comprises a display module for displaying the path information.

Wherein, the path information includes a traveling distance, an estimated time and a guide route.

To achieve the objective of the present invention, the invention further provides a fast path planning method comprising the steps of: storing an expressway map and an urban road map in a map database; inputting a destination by an input module; calculating a current location of the navigation apparatus by a positioning module according to a global positioning system signal, the expressway map and the urban road map; providing a processing module for calculating path information from the current location of the navigation apparatus to an entrance ramp according to the expressway map and the urban road map; and providing the processing module for calculating path information from an exit ramp to the destination according to the expressway information, the expressway map and the urban road map.

Wherein, this method further comprises the step of providing an external computer for calculating expressway information from an entrance ramp to an exit ramp according to the expressway map.

Wherein, this method further comprises the step of storing expressway information from the entrance ramp to the exit ramp into the map database.

Wherein, this method further comprises the step of displaying path information by a display module.

Wherein, this method further comprises the step of providing a processing module for calculating a traveling distance, an estimated time and a guide route according to the expressway information, the expressway map and the urban road map.

In summation of the description above, the fast path planning navigation apparatus and the method thereof in accordance with the present invention calculate the path information from the current location of the navigation apparatus to the entrance ramp and from the exit ramp to the destination according to the expressway information, the expressway map and the urban road map by the processing module. The external computer calculates the expressway information from the entrance ramp to the exit ramp according to expressway map in advance. Thus, the present invention achieves the effects of expediting the calculation for planning the long-distance path, improving the calculation performance, and saving the calculation time.

The foregoing and other objectives, technical characteristics and advantages of the present invention will become apparent with the detailed description of preferred embodiments accompanied with related drawings as follows.

### BRIEF DESCRIPTION OF THE DRAWINGS

FIG. 1 is a block diagram of a navigation apparatus of the present invention;

FIG. 2 is a flow chart of a fast path planning method in accordance with a first preferred embodiment of the present invention;

FIG. 3 is a flow chart of a fast path planning method in accordance with a second preferred embodiment of the present invention; and

FIG. 4 is a schematic view of a navigation apparatus of the present invention.

### DETAILED DESCRIPTION OF THE PREFERRED EMBODIMENTS

Understanding of the present invention will be facilitated by consideration of the detailed description of the following preferred embodiments of the present invention, taken in conjunction with the accompanying drawings, in which same reference numerals refer to same respective parts respectively.

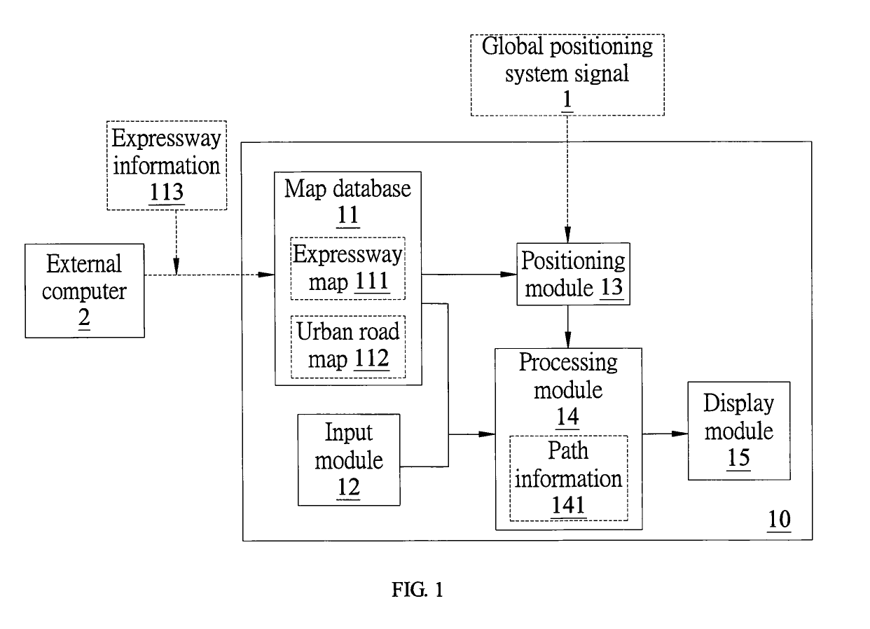

With reference to FIG. 1 for a block diagram of a navigation apparatus of the present invention, the navigation apparatus 10 comprises a map database 11, an input module 12, a positioning module 13 and a processing module 14. The map database 11 is provided for storing an expressway map 111 and an urban road map 112. The input module 12 is provided for inputting a destination. The positioning module 13 is provided for calculating a current location of the navigation apparatus 10 according to a global positioning system signal 1, the expressway map 111 and the urban road map 112. The processing module 14 is provided for calculating path information 141 from the current location of the navigation apparatus 10 to the entrance ramp and from the exit ramp to the destination according to the expressway information 113, the expressway map 111 and the urban road map 112. The path information 141 further includes a path planning result such as a traveling distance, an estimated time, and a guide route.

In the meantime, the navigation apparatus 10 has an external computer 2 installed at a remote position for calculating the expressway information 113 from the entrance ramp to the exit ramp according to the expressway map 111, and storing the expressway information 113 in the map database 11. The expressway information 113 includes information such as a ramp distance, a speed limit, and a toll station, and the ramp distance is used in a preferred embodiment for illustrating the invention as follows, but the expressway information 113 of the present invention is not limited to the ramp distance only. The navigation apparatus 10 further comprises a display module 15 for displaying path information 141.

The expressway map 111 of the present invention includes map information of freeways, highways, and flyovers. For simplicity, highways are used in the preferred embodiment for illustrating the technical characteristics of the present invention, but the invention is not limited to highways only.

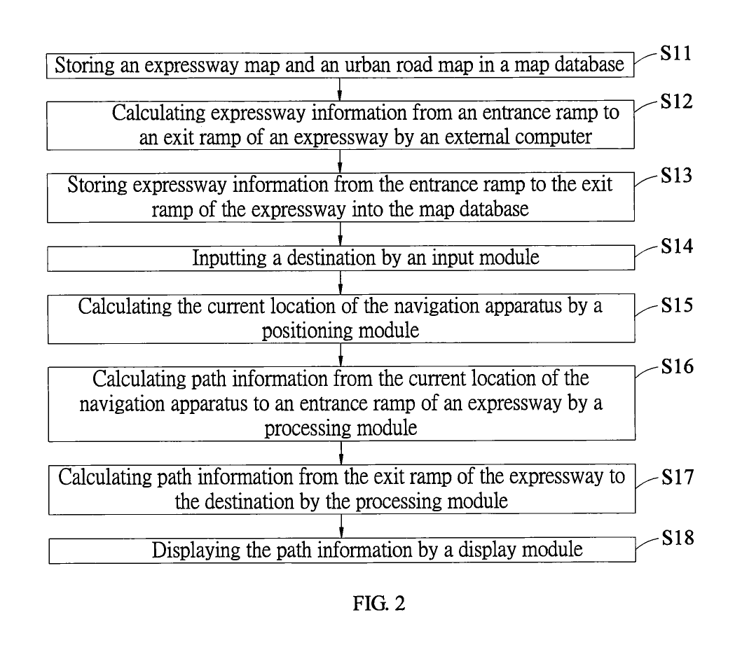

With reference to FIG. 2 for a fast path planning method in accordance with a first preferred embodiment of the present invention together with FIG. 1. As shown in Steps S11, S12 and S13. In Step S11, a map database is provided for storing an expressway map and an urban road map. In Step S12, an external computer is provided for calculating expressway information from an entrance ramp to an exit ramp according to the expressway map. In Step S13, the expressway information from the entrance ramp to the exit ramp is stored in the map database. In Step S11, the expressway map contains map information of freeways, highways and flyovers. For simplicity, freeways are used in this preferred embodiment for illustrating the technical characteristics of the present invention, but the invention is not limited to freeways only.

In Steps S12 and S13, an external computer is installed at a remote position, and the high-performance computer is provided for calculating a large volume of data at the remote position. Therefore, the external computer can be used for calculating the expressway information from an entrance ramp of a freeway to an exit ramp of the freeway, and the map database can be used for storing the expressway information. Wherein, the expressway information includes information such as a ramp distance, a speed limit or a toll station, and the ramp distance is used in this preferred embodiment for illustrating the invention.

As shown in Steps S14 to Step S17. S14: an input module is provided for inputting a destination; S15: a positioning module is provided calculating a current location of the navigation apparatus according to a global positioning system signal, the expressway map and the urban road map; S16: a processing module is provided for calculating path information from the current location of the navigation apparatus to an entrance ramp according to the expressway information, the expressway map and the urban road map; and S17: a processing module is provided for calculating path information from an exit ramp to the destination according to the expressway information, the expressway map and the urban road map.

It is noteworthy to point out that the external computer is used in Step S12 to calculate the expressway information and obtain results, such that the calculation of the path information in Steps S16 and S17 can be expedited.

Finally, as shown in Step S18. S18: the display module is used to display the path information, wherein the path information includes path planning result such as a traveling distance, an estimated time and a guide route.

It is noteworthy to point out that the fast path planning method of the present invention can be applied to a mobile device such as a smart phone, a personal computer or a personal digital assistant.

Based on the first preferred embodiment, the present invention further provides a second preferred embodiment for illustrating the invention further.

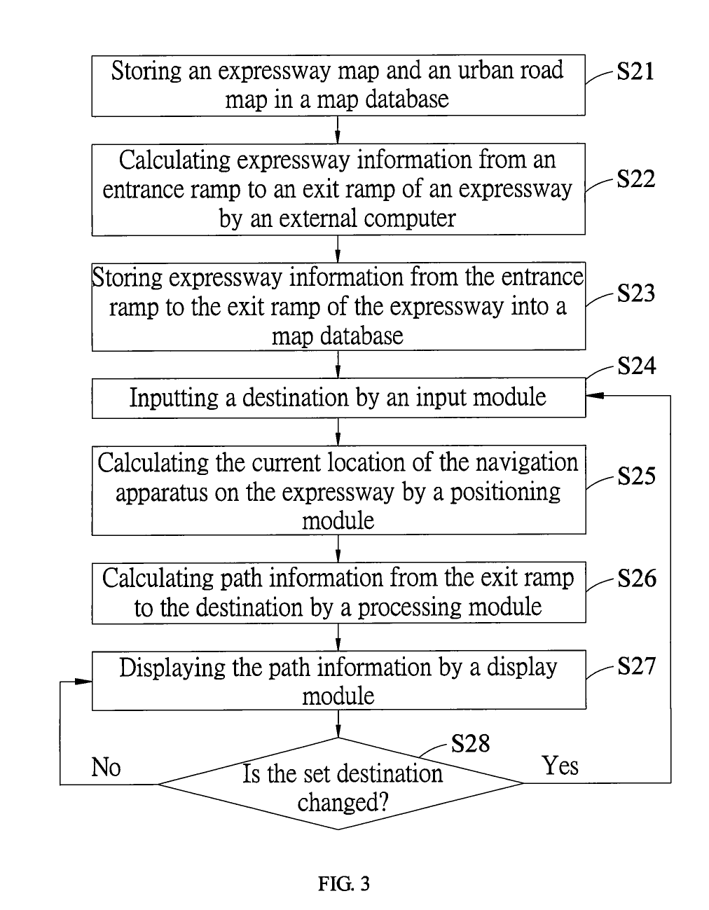

With reference to FIG. 3 for a flow chart of a fast path planning method in accordance with a second preferred embodiment of the present invention, the expressway map stored in the map database of the present invention includes map information of freeways, highways and flyovers. For simplicity, freeways are used in the following preferred embodiment for illustrating the technical characteristics of the present invention, but the present invention is not limited to freeways only.

Please refer to FIG. 3 together with FIG. 1. As shown in Steps S21, S22 and S23. S21: a map database is provided for storing an expressway map and an urban road map; S22: an external computer is provided for calculating expressway information from an entrance ramp to an exit ramp according to the expressway map; and S23: a map database is provided for storing the expressway information from the entrance ramp to the exit ramp. In Step S21, the expressway map includes map information of freeways, highways and flyovers. For simplicity, freeways are used in this preferred embodiment for illustrating the technical characteristics of the present invention, but the invention is not limited to freeways only.

In Steps S22 and S23, the external computer is installed at a remote position, and the computer capable of calculating a large volume of data can be used to calculate the expressway information of all freeways in advance. Wherein, the expressway information includes information of a ramp distance, a speed limit or a toll station, and the ramp distance is used in this preferred embodiment for illustrating the invention.

As shown in Steps S24 and S25. In Step S24, an input module is provided for inputting a destination; and in Step S25, a positioning module is provided for calculating a current location of the navigation apparatus at a freeway according to a global positioning system signal, the expressway map and the urban road map. For example, if a user sets off from Beijing-Tianjin freeway to Shanghai, the destination “Shanghai” is inputted from the input module according to Step S24, and the positioning module is provided for calculating the location of the navigation apparatus on the Beijing-Tianjin Freeway. According to the calculation of the external computer, the map database includes the information of 14 Freeways: Beijing-Tianjin Freeway, Beijing-Shanghai Freeway, Tianjin-Jin Freeway, Rong-Wu Freeway, Changchun-Shenzhen Freeway, Bin-Bo Freeway, Bo-Lai Freeway, Lai-Xin Freeway, Lian-Su Freeway, Costal Freeway, Riverside Freeway, Shenhai Freeway, Shanghai-Chongqing Freeway and Yan-An Flyover.

The aforementioned fourteen freeways are roads that must be passed by a traveler who sets off from Beijing-Tianjin Highway to Shanghai. As shown in Steps S26 and S27. In Step S26, a processing module is provided for calculating path information from an exit ramp to the destination according to the expressway information, the expressway map and the urban road map.

It is noteworthy to point out that the expressway information calculated by the external computer in Step S22 is used, such that the calculation of the path information in Step S26 can be expedited. As described in Step S27, the display module is provided for displaying the path information. Wherein, the path information includes a path planning result such as a traveling distance, an estimated time and a guide route.

In the wake of Step S27 is Step S28. Step S28 is to determine whether or not the destination is changed. If the destination is changed, then the procedure returns to Step S24, or else the procedure returns to Step S27.

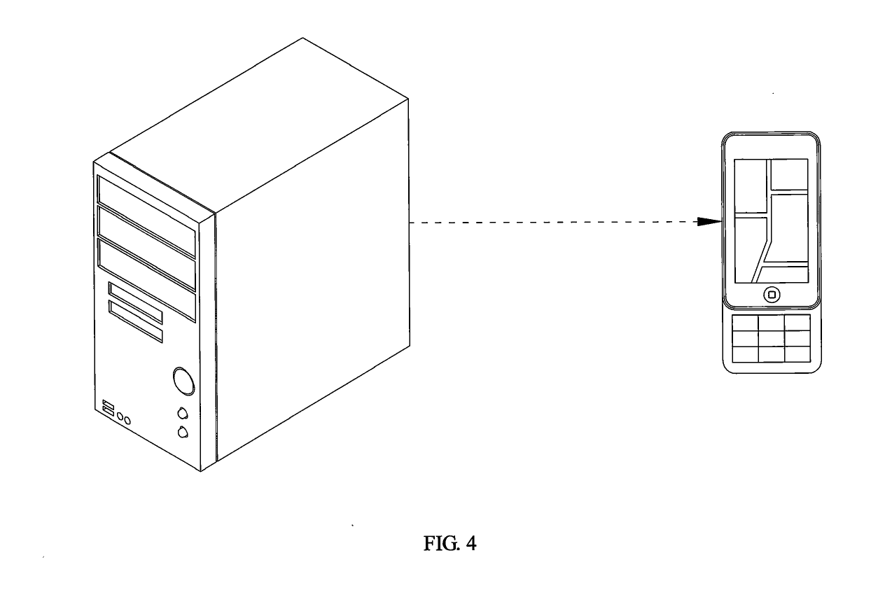

With reference to FIG. 4 for a schematic view of a navigation apparatus of the present invention, the fast path planning method of the present invention can be applied to a mobile device such as a smart phone, a personal computer or a personal digital assistant. The smart phone is used in this preferred embodiment for illustrating the technical characteristics of the present invention, but the invention is not limited to the smart phone only. An external computer is provided for calculating the expressway information and storing the calculation results in the smart phone. The smart phone comprises an input module and a display module for inputting the destination and displaying the planned path information respectively.

In summation of the description above, the fast path planning navigation apparatus and the method thereof in accordance with the present invention have one or more of the following advantages:

(a) The invention overcomes the problems of the prior art that it takes too much calculation time for the navigation apparatus to plan a long-distance path and the navigation apparatus tends to crash, the memory of the navigation apparatus tends to be insufficient and so on.

(b) The fast path planning navigation apparatus and the method thereof in accordance with the present invention can calculate the expressway information from the entrance ramp to the exit ramp according to the expressway map by the external computer in advance. The processing module is provided for calculating the path information from the current location of the navigation apparatus to the entrance ramp and from the exit ramp to the destination according to the expressway information, the expressway map and the urban road map. Thus, the present invention achieves the effects of expediting the calculation of the path planning, reducing the calculation time for planning the long-distance path to approximately 30%, improving the calculation performance, and saving the calculation time.

While particular embodiments of the present invention have been shown and described, it will be obvious to those skilled in the art that, based upon the teachings herein, changes and modifications may be made without departing from this invention and its broader aspects. Therefore, the appended claims are intended to encompass within their scope of all such changes and modifications as are within the true spirit and scope of the exemplary embodiment(s) of the present invention.

What is claimed is:

1. A navigation apparatus, comprising:
a map database storing an expressway map and an urban road map;
an input module inputting a destination;
a positioning module calculating a current location of the navigation apparatus according to a global positioning system signal, the expressway map and the urban road map; and
a processing module calculating a path information from the current location of the navigation apparatus to an entrance ramp and from an exit ramp to the destination according to an expressway information, the expressway map and the urban road map.

2. The navigation apparatus of claim 1, further comprising an external computer for calculating the expressway information from the entrance ramp to the exit ramp according to the expressway map.

3. The navigation apparatus of claim 2, wherein the map database further stores the expressway information from the entrance ramp to the exit ramp.

4. The navigation apparatus of claim 1, further comprising a display module for displaying the path information.

5. The navigation apparatus of claim 1, wherein the path information includes a traveling distance, an estimated time and a guide route.

6. A fast path planning method applicable to a navigation apparatus, and comprising the steps of:
storing an expressway map and an urban road map by a map database;
inputting a destination by an input module;
calculating a current location of the navigation apparatus by a positioning module according to a global positioning system signal, the expressway map and the urban road map;
providing a processing module for calculating path information from the current location of the navigation apparatus to an entrance ramp according to an expressway information, the expressway map and the urban road map; and
providing the processing module for calculating a path information from an exit ramp to the destination according to the expressway information, the expressway map and the urban road map.

7. The fast path planning method of claim 6, further comprising the step of providing an external computer for calculating the expressway information from an entrance ramp to an exit ramp according to the expressway map.

8. The fast path planning method of claim 7, further comprising the step of storing the expressway information from the entrance ramp to the exit ramp into the map database.

9. The fast path planning method of claim 6, further comprising the step of displaying the path information by a display module.

10. The fast path planning method of claim 6, further comprising the step of calculating a traveling distance, an estimated time and a guide route by the processing module according to the expressway information, the expressway map and the urban road map.
